(19) United States
(12) Patent Application Publication
(10) Pub. No.: US 2026/0087800 A1
(43) Pub. Date: Mar. 26, 2026

(54) SYSTEMS AND METHODS FOR INFRASTRUCTURE MONITORING

(71) Applicant: AIDash Inc., Palo Alto, CA (US)

(72) Inventors: Shantanu Rajora, San Francisco, CA (US); Amit Jain, San Jose, CA (US); Abhishek Vinod Singh, Fremont, CA (US)

(73) Assignee: AIDash Inc., Palo Alto, CA (US)

(21) Appl. No.: 19/337,833

(22) Filed: Sep. 23, 2025

Related U.S. Application Data
(60) Provisional application No. 63/698,019, filed on Sep. 23, 2024.

(51) Int. Cl. G06V 20/10; A62C 3/02; G06T 7/00; G06T 7/11; G06V 10/25; G06V 10/46; G06V 10/58; G06V 10/82; G06V 20/13

(52) U.S. Cl. CPC G06V 20/188; A62C 3/02; G06T 7/0004; G06T 7/11; G06V 10/25; G06V 10/46; G06V 10/58; G06V 10/82; G06V 20/13; G06T 2207/10028; G06T 2207/10036; G06T 2207/10048; G06V 2201/07

(57) ABSTRACT

An example method includes receiving asset data for infrastructure assets in a geographic area, satellite images of the geographic area, and requirements data including one or more requirements relating to the infrastructure assets or the geographic area. A least a portion of the geographic area is divided into geographic sub-areas, and one or more trained models are applied to the satellite images and the requirements data to select a data acquisition modality from multiple data acquisition modalities for each geographic sub-area. A request to receive data of the data acquisition modality is generated for a geographic sub-area. Data captured by the data acquisition modality is received. Based on the data, one or more analytic outputs for the geographic sub-area or electrical assets located in the geographic sub-area are generated or updated. The one or more analytic outputs are provided.

### CROSS-REFERENCE TO RELATED APPLICATION

This application claims priority to and the benefit of U.S. Provisional Patent Application No. 63/698,019 filed on Sep. 23, 2024, and entitled “Systems and Methods for AI-Driven Multi-Sensor Vegetation Management System for Utility Right-of-Ways,” which is incorporated in its entirety herein by reference.

### Field of the Invention(s)

Embodiments of the present invention(s) are generally related to infrastructure monitoring, and in particular to monitoring infrastructure assets of utilities.

### Background

Electrical utilities face significant challenges in managing vegetation encroachments along their right-of-ways (ROWs). Traditional methods of inspection rely on either satellite (mutispectral and thermal) imagery, Aerial LiDAR (Light Detection and Ranging), or vehicle-mounted sensor technology, each with its own set of advantages and limitations. LiDAR scans provide high accuracy but may be relatively expensive and time-consuming, making full-scale deployment prohibitive for many utilities. Satellite-based remote sensing offers scalability and affordability but lacks the precision of LiDAR in certain situations. Other remote sensing technologies have limitations.

### SUMMARY

In some aspects, the techniques described herein relate to a non-transitory computer-readable medium including executable instructions, the executable instructions being executable by one or more processors to perform a method, the method including: receiving asset data for electrical assets of an electrical power distribution infrastructure, the electrical assets located in a geographic area, the asset data including locations of the electrical assets in the geographic area; receiving, based on the locations of the electrical assets, first satellite images of the geographic area, the first satellite images having a first resolution; determining, based on the first satellite images, vegetation indicators for portions of the geographic area that include the electrical assets; receiving requirements data, the requirements data including one or more requirements relating to the electrical assets or the geographic area; dividing at least a portion of the geographic area into geographic sub-areas; applying one or more trained models to the vegetation indicators and the requirements data to select a data acquisition modality from multiple data acquisition modalities for each of the geographic sub-areas, the multiple data acquisition modalities including: one or more satellites configured to capture satellite data, the satellite data including second satellite images, at least some of the second satellite images having a second resolution different from the first resolution, one or more aerial modalities configured to capture aerial data from the air, the aerial data including one or more of images, LiDAR data, hyperspectral data, infrared data, ultraviolet data, or other sensor data, and one or more surface modalities configured to capture surface data from the surface, the surface data including one or more of images, LiDAR data, hyperspectral data, infrared data, ultraviolet data, or other sensor data; generating, for a particular geographic sub-area, a request to receive data of the data acquisition modality selected for the particular geographic sub-area; receiving, based on the request, data captured by the data acquisition modality selected for the particular geographic sub-area; generating or updating, based on the data captured by the data acquisition modality selected for the particular geographic sub-area, one or more analytic outputs for the particular geographic sub-area or particular electrical assets located in the particular geographic sub-area; and providing the one or more analytic outputs for the particular geographic sub-area or the particular electrical assets located in the particular geographic sub-area.

In some aspects, the techniques described herein relate to a non-transitory computer-readable medium wherein the one or more trained models are also applied to the vegetation indicators and the requirements data to determine a frequency or timing of capture of the data acquisition modality.

In some aspects, the techniques described herein relate to a non-transitory computer-readable medium wherein the one or more analytic outputs are one or more second analytic outputs, and the method further includes generating, based on the vegetation indicators, one or more first analytic outputs, wherein generating or updating the one or more analytic outputs for the particular geographic sub-area or the particular electrical assets located in the particular geographic sub-area includes updating, further based on the one or more second analytic outputs, the one or more first analytic outputs.

In some aspects, the techniques described herein relate to a non-transitory computer-readable medium wherein the vegetation indicators include one or more of vegetation densities or distances from vegetation to the electrical assets.

In some aspects, the techniques described herein relate to a non-transitory computer-readable medium wherein the one or more requirements include a wildfire risk assessment for the geographic area, and the one or more analytic outputs include the wildfire risk assessment for the particular geographic sub-area.

In some aspects, the techniques described herein relate to a non-transitory computer-readable medium wherein the one or more requirements include a hazard tree assessment for the geographic area, and the one or more analytic outputs include the hazard tree assessment for the particular geographic sub-area.

In some aspects, the techniques described herein relate to a non-transitory computer-readable medium, the method further including: receiving building data for the geographic area, the building data including one or more locations of one or more buildings in the geographic area; and receiving terrain data for the geographic area, the terrain data including land use and land cover data for the geographic area, wherein the one or more trained models are also applied to the building data and the terrain data to select the data acquisition modality from the multiple data acquisition modalities for each of the geographic sub-areas.

In some aspects, the techniques described herein relate to a non-transitory computer-readable medium, the method further including receiving historical wildfire data for the geographic area, the historical wildfire data including portions of the geographic area affected by historical wildfire, wherein the one or more trained models are also applied to the historical wildfire data to select the data acquisition modality from the multiple data acquisition modalities for each of the geographic sub-areas.

In some aspects, the techniques described herein relate to a non-transitory computer-readable medium, the method further including receiving historical outage data for the electrical assets, the historical outage data including the electrical assets affected by historical outages, wherein the one or more trained models are also applied to the historical outage data to select the data acquisition modality from the multiple data acquisition modalities for each of the geographic sub-areas.

In some aspects, the techniques described herein relate to a non-transitory computer-readable medium, the method further including receiving weather data for the geographic area, the weather data including one or more of historical weather data for the geographic area or forecasted weather data for the geographic area, wherein the one or more trained models are also applied to the weather data to select the data acquisition modality from the multiple data acquisition modalities for each of the geographic sub-areas.

In some aspects, the techniques described herein relate to a non-transitory computer-readable medium, the method further including receiving vegetation management data for the electrical assets, the vegetation management data including historical vegetation management activities proximate to the electrical assets, wherein the one or more trained models are also applied to the vegetation management data to select the data acquisition modality from the multiple data acquisition modalities for each of the geographic sub-areas.

In some aspects, the techniques described herein relate to a method including: receiving asset data for infrastructure assets located in a geographic area; receiving first satellite images of the geographic area, the first satellite images having a first resolution; receiving requirements data, the requirements data including one or more requirements relating to the infrastructure assets or the geographic area; dividing at least a portion of the geographic area into geographic sub-areas; applying one or more trained models to the first satellite images and the requirements data to select a data acquisition modality from multiple data acquisition modalities for each of the geographic sub-areas, the multiple data acquisition modalities including: one or more satellites configured to capture satellite data, the satellite data including second satellite images, at least some of the second satellite images having a second resolution different from the first resolution, one or more aerial modalities configured to capture aerial data from the air, the aerial data including one or more of images, LiDAR data, hyperspectral data, infrared data, ultraviolet data, or other sensor data, and one or more surface modalities configured to capture surface data from the surface, the surface data including one or more of images, LiDAR data, hyperspectral data, infrared data, ultraviolet data, or other sensor data; generating, for a particular geographic sub-area, a request to receive data of the data acquisition modality selected for the particular geographic sub-area; receiving data captured by the data acquisition modality; generating or updating, based on the data captured by the data acquisition modality, one or more analytic outputs for the particular geographic sub-area or particular electrical assets located in the particular geographic sub-area; and providing the one or more analytic outputs for the particular geographic sub-area or the particular electrical assets located in the particular geographic sub-area.

In some aspects, the techniques described herein relate to a method, further including wherein the one or more trained models are also applied to the first satellite images and the requirements data to determine a frequency or timing of capture of the data acquisition modality.

In some aspects, the techniques described herein relate to a method wherein the one or more analytic outputs are one or more second analytic outputs, and further including generating, based on the first satellite images, one or more first analytic outputs, wherein generating or updating the one or more analytic outputs for the particular geographic sub-area or the particular electrical assets located in the particular geographic sub-area includes updating, further based on the one or more second analytic outputs, the one or more first analytic outputs.

In some aspects, the techniques described herein relate to a method wherein the one or more requirements include a wildfire risk assessment for the geographic area, and the one or more analytic outputs include the wildfire risk assessment for the particular geographic sub-area.

In some aspects, the techniques described herein relate to a method wherein the one or more requirements include a hazard tree assessment for the geographic area, and the one or more analytic outputs include the hazard tree assessment for the particular geographic sub-area.

In some aspects, the techniques described herein relate to a method, further including: receiving building data for the geographic area, the building data including one or more locations of one or more buildings in the geographic area; and receiving terrain data for the geographic area, the terrain data including land use and land cover data for the geographic area, wherein the one or more trained models are also applied to the building data and the terrain data to select the data acquisition modality from the multiple data acquisition modalities for each of the geographic sub-areas.

In some aspects, the techniques described herein relate to a method, the method further including receiving historical wildfire data for the geographic area, the historical wildfire data including portions of the geographic area affected by historical wildfire, wherein the one or more trained models are also applied to the historical wildfire data to select the data acquisition modality from the multiple data acquisition modalities for each of the geographic sub-areas.

In some aspects, the techniques described herein relate to a method, the method further including receiving historical outage data for the infrastructure assets, the historical outage data including the infrastructure assets affected by historical outages, wherein the one or more trained models are also applied to the historical outage data to select the data acquisition modality from the multiple data acquisition modalities for each of the geographic sub-areas.

In some aspects, the techniques described herein relate to a method, the method further including receiving weather data for the geographic area, the weather data including one or more of historical weather data for the geographic area or forecasted weather data for the geographic area, wherein the one or more trained models are also applied to the weather data to select the data acquisition modality from the multiple data acquisition modalities for each of the geographic sub-areas.

In some aspects, the techniques described herein relate to a method, the method further including receiving vegetation management data for the infrastructure assets, the vegetation management data including historical vegetation management activities proximate to the infrastructure assets, wherein the one or more trained models are also applied to the vegetation management data to select the data acquisition modality from the multiple data acquisition modalities for each of the geographic sub-areas.

In some aspects, the techniques described herein relate to a system including at least one processor and at least one memory including executable instructions that when executed by the at least one processor cause the system to: receive asset data for infrastructure assets located in a geographic area; receive first satellite images of the geographic area, the first satellite images having a first resolution; receive requirements data, the requirements data including one or more requirements relating to the infrastructure assets or the geographic area; divide at least a portion of the geographic area into geographic sub-areas; apply one or more trained models to the first satellite images and the requirements data to select a data acquisition modality from multiple data acquisition modalities for each of the geographic sub-areas, the multiple data acquisition modalities including: one or more satellites configured to capture satellite data, the satellite data including second satellite images, at least some of the second satellite images having a second resolution different from the first resolution, one or more aerial modalities configured to capture aerial data from the air, the aerial data including one or more of images, LiDAR data, hyperspectral data, infrared data, ultraviolet data, or other sensor data, and one or more surface modalities configured to capture surface data from the surface, the surface data including one or more of images, LiDAR data, hyperspectral data, infrared data, ultraviolet data, or other sensor data; generate, for a particular geographic sub-area, a request to receive data of the data acquisition modality selected for the particular geographic sub-area; receive data captured by the data acquisition modality; generate or update, based on the data captured by the data acquisition modality, one or more analytic outputs for the particular geographic sub-area or particular electrical assets located in the particular geographic sub-area; and provide the one or more analytic outputs for the particular geographic sub-area or the particular electrical assets located in the particular geographic sub-area.

### BRIEF DESCRIPTION OF THE DRAWINGS

FIG. 1 depicts an example environment in which an infrastructure monitoring system may operate in some embodiments.

FIG. 2 depicts a block diagram of an example infrastructure monitoring system in some embodiments.

FIG. 3A depicts a geographic area where electrical assets may be located in some embodiments.

FIG. 3B depicts a zoomed-in portion of the geographic area of FIG. 3A.

FIG. 3C depicts an example architecture of an infrastructure monitoring system according to some embodiments.

FIG. 4 is a flow diagram depicting a method for selection and fusion of data acquisition modalities for infrastructure asset monitoring in some embodiments.

FIG. 5A is a diagram depicting example asset data for electrical assets of an electrical power distribution infrastructure located in a geographic area according to some embodiments.

FIG. 5B is a diagram depicting a geographic area divided into sub-areas for analysis of electrical assets according to some embodiments.

FIG. 6A is a diagram depicting wildfire risk and the impact of wildfires on infrastructure assets according to some embodiments.

FIG. 6B is a diagram depicting hazard tree risk and the impact of hazard trees on utility assets in some embodiments.

FIG. 7A is a diagram depicting an example analytic output according to some embodiments.

FIG. 7B is a diagram depicting another example analytic output in some embodiments.

FIG. 8 depicts a block diagram of an example digital device in some embodiments.

Throughout the drawings, like reference numerals will be understood to refer to like parts, components, and structures.

### DETAILED DESCRIPTION

Current approaches do not include mechanisms for intelligently selecting the most suitable modality or determining the optimal cadence of acquisition for a given infrastructure asset or geographic area. As a result, current methods are inefficient, produce redundant data, and increase operational cost. There exists a need for systems and methods that can leverage multiple heterogeneous data sources and dynamically select the appropriate modality and frequency, which may thereby result in scalable and cost-effective asset management.

Utilities with extensive networks spanning diverse geographical areas encounter varying conditions that require different levels of inspection granularity. Dense vegetation areas may require higher resolution data, while sparse vegetation zones may be adequately monitored with lower resolution methods.

Some embodiments described herein relate to an infrastructure monitoring system. Among other things, the infrastructure monitoring system may utilize data relating to infrastructure assets, satellite images (or other sensed data), and requirements relating to the infrastructure assets to select data acquisition modalities for monitoring the infrastructure assets. The infrastructure monitoring system may employ advanced machine learning algorithms or artificial intelligence techniques to determine an effective combination of data acquisition modalities for a geographic area. In some cases, the data acquisition modalities include satellites, aerial modalities such airplanes, helicopters, or drones, and surface modalities, such as ground vehicles or sensors attached to infrastructure assets. The infrastructure monitoring system may receive data from the data acquisition modalities and fuse the received data with existing data for the infrastructure assets. The infrastructure monitoring system may thereby optimize or improve the use of multiple data acquisition modalities based on infrastructure maintenance requirements, budget constraints, or geographical conditions.

An example process is described. The infrastructure monitoring system may utilize satellite imagery (for example, the latest satellite imagery) and advanced machine learning algorithms or artificial intelligence techniques to analyze all or a portion of a right of way (ROW) of a utility. The infrastructure monitoring system may identify which segments of the utility network require specific types of data acquisition modalities based on vegetation density, critical infrastructure, or other relevant factors. The infrastructure monitoring system may recommend a mix of data acquisition modalities and inspection frequencies for different network segments (for example, based on the network analysis). One example allocation may include 50% satellite imaging, 25% LiDAR scanning (every 3 years), and 25% aerial inspections (every 2 years).

The infrastructure monitoring system may coordinate data collection from various sources. Sources may include satellite operators, aerial imagery providers, or LiDAR operators. The infrastructure monitoring system may integrate the data for analysis. The infrastructure monitoring system may employ data fusion techniques to combine and analyze data from multiple data acquisition modalities. This fusion process may enable data from different sources complement and strengthen each other, providing more comprehensive and accurate insights.

The infrastructure monitoring system may leverage historical high-resolution data (for example, LiDAR scans) to enhance the analysis of current lower-resolution data (for example, satellite imagery). For example, LiDAR data obtained in a first year is used to improve satellite-based analytics obtained in a second year for the same geographic area. Based on the insights gained from data fusion, the infrastructure monitoring system may continuously improve or optimize data acquisition modality allocation. For example, geographic areas that received high-resolution scans in previous years may be allocated lower-resolution methods in subsequent years, allowing reallocation of high-resolution methods to other geographic areas for improved overall coverage.

The fused and analyzed data may be used to generate actionable insights for vegetation management, asset health assessment, and risk evaluation (for example, wildfire and storm risks). These insights may be integrated into a utility's workflow applications for efficient operation and management. Moreover, the infrastructure monitoring system may adapt to changes in budget allocation. For example, if additional funds are available, the infrastructure monitoring system may determine where to deploy higher-quality sensors (for example, LiDAR or aerial imaging) for maximum ROI. In case of budget constraints, the infrastructure monitoring system may identify areas where cheaper sensors (for example, satellites) can be used, or inspection frequencies can be reduced while minimizing impact on overall vegetation management effectiveness.

The infrastructure monitoring system may provide numerous advantages. One advantage may be that the infrastructure monitoring system improves or optimizes the use of expensive high-resolution sensors while maximizing coverage with more affordable options. Another advantage is that the infrastructure monitoring system may flexibly adjust data acquisition modalities to changing budgets and priorities of a utility. Another advantage is that the infrastructure monitoring system provides a holistic view of the utility network by combining data from multiple sources. The infrastructure monitoring system is scalable and may be suitable for utilities of various sizes and geographical spreads. Another advantage is that the infrastructure monitoring system continuously improves recommendations based on historical data and outcomes. The infrastructure monitoring system also may enhance a utility's ability to identify and address potential hazards proactively. Other advantages will be apparent.

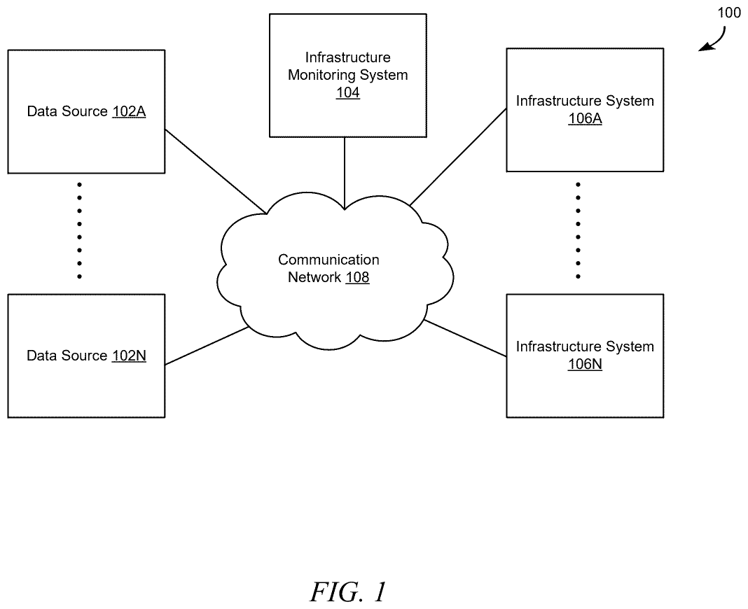

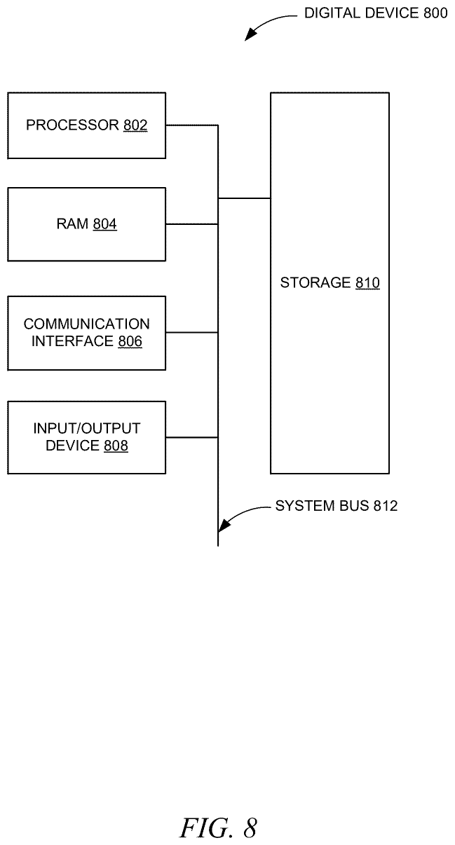

FIG. 1 depicts an example environment 100 in which an infrastructure monitoring identification system may operate in some embodiments. The environment 100 includes multiple data sources 102A through 102N (which may be referred to as a data source 102 or as data sources 102), multiple infrastructure systems 106A through 106N (which may be referred to as an infrastructure system 106 or as infrastructure systems 106), an infrastructure monitoring system 104, and a communication network 108. Each of the data sources 102, the infrastructure monitoring system 104, and the infrastructure system 106 may be or include any number of digital devices. A digital device is any device with at least one processor and memory. Digital devices are discussed further herein, for example, with reference to FIG. 8.

Data sources 102A to 102N may each be a third party system configured to provide data or access to data. For example, different third parties may periodically capture images, LiDAR data, hyperspectral data, infrared data, ultraviolet data, or other sensor data of geographic areas. For example, some third parties may obtain such data of geographic areas from satellites, airplanes, helicopters, or drones at regular intervals or on-demand for a variety of purposes. Satellite images may be images of geographic areas of the Earth collected by imaging satellites operated by governments and businesses. Different third parties may obtain images from different sources (for example, different satellites, airplanes, helicopters, drones, or the like) for the same or different geographic areas. The third parties may provide images or license access to the images to other businesses for a variety of purposes (for example, via one or more of data sources 102A to 102N). As another example, third parties or infrastructure owners or operators may obtain data from surface modalities that capture surface data from the surface, such as from ground vehicles, sensors attached to infrastructure assets, or sensing devices carried by individuals surveying the infrastructure assets. Such surface data may include images, LiDAR data, hyperspectral data, infrared data, ultraviolet data, or other sensor data (for example, vibration data from sensors attached to electrical utility poles or towers).

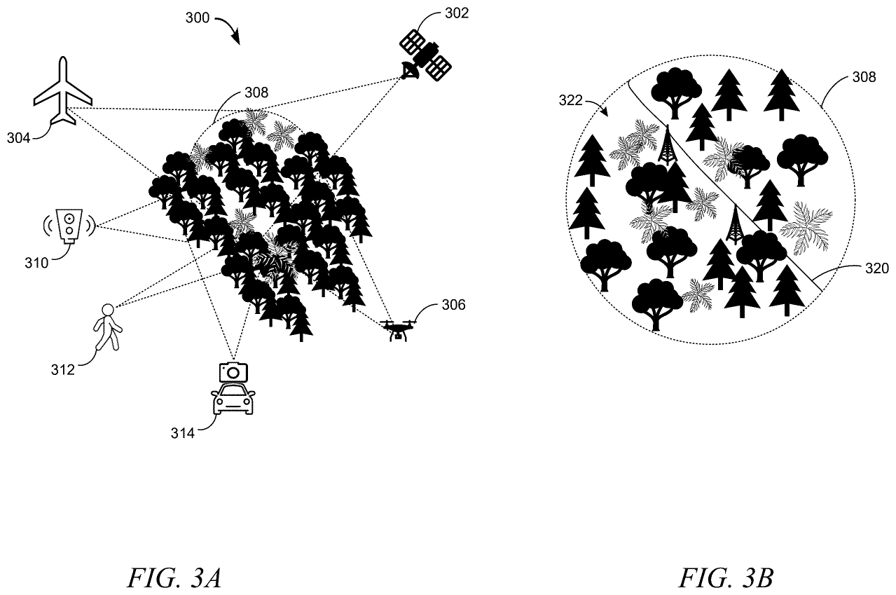

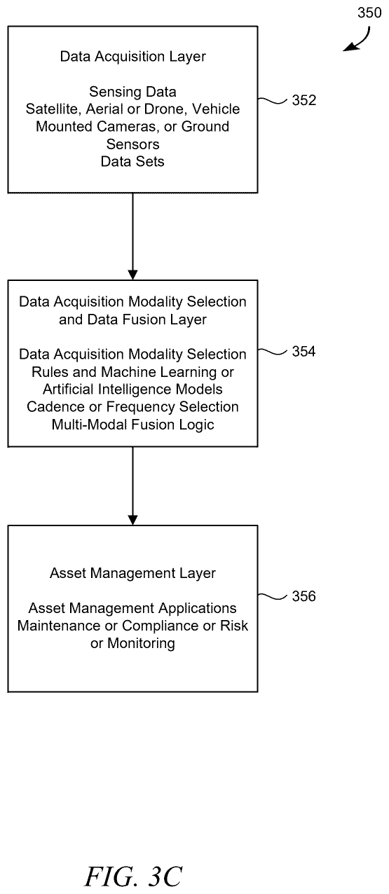

FIG. 3A depicts a geographic area 300 where infrastructure assets, such as electrical assets of an electrical power distribution infrastructure (which may also be referred to as an electrical utility), may be located in some embodiments. Depending upon capabilities and configurations, aerial modalities such as a satellite 302, an aircraft 304, or a drone 306 may capture images, LiDAR data, hyperspectral data, infrared data, ultraviolet data, or other sensor data. Captured data or other information (for example, geographic coordinates and the like) may be stored and provided to others via one or more data sources 102A to 102N. Similarly, depending upon capabilities and configurations, surface modalities such as a LiDAR 310 (for example, mounted to a surface vehicle), a camera or other sensing device carried by an individual 312, or a camera 314 (for example, mounted to a surface vehicle) may capture images, LiDAR data, hyperspectral data, infrared data, ultraviolet data, or other sensor data.

FIG. 3B depicts an example zoomed-in portion 308 of the geographic area 300 of FIG. 3A. The zoomed-in portion 308 depicts that the geographic area 300 includes an electrical asset 320, which includes an electrical powerline, such as a transmission line or a distribution line. The electrical asset 320 may include the towers or poles to which the electrical powerline is attached, or such towers or poles may be considered as separate electrical assets. The geographic area 300 also includes vegetation 322, such as trees. As discussed further herein, the infrastructure monitoring system 104 may utilize satellite images to detect the vegetation 322 (and other vegetation) that is proximate to the electrical asset 320 (and other electrical assets). The infrastructure monitoring system 104 may determine vegetation indicators such as vegetation density for portions of the geographic area 300 (and other geographic areas) that include the electrical asset 320 (and other electrical assets).

Returning to FIG. 1, in some embodiments, any number of the data sources 102A to 102N may obtain images of the same geographic area (for example, from satellites, aircraft, or drones) and save them over time. As such, a data source 102 may obtain and store images of the same geographic site taken on different days, months, or years. For example, a data source 102 may provide images at a first duration of time (for example, taken at a particular time and date). The data source 102 may also provide images of the same geographic areas for a second duration (for example, taken at a different particular time or date, such as one or more years before or after the first duration).

Any number of the data sources 102A to 102N may provide application programming interfaces (APIs) to enable another system (for example, the infrastructure monitoring system 104) to request images for a particular geographic area. The request may be or include a request for current images or for images of the same geographic areas taken at different times. In various embodiments, the infrastructure monitoring system 104 may request information on what geographic area images are available and at what time frames. A geographic area may be any portion of the Earth.

The infrastructure monitoring system 104 may be configured to receive images of any number of geographic areas. The infrastructure monitoring system 104 may utilize the images and other data for various purposes, to identify hazard trees that may interfere with the safety and operation of assets of a local distribution network or a high-voltage distribution network (which alone or together may be referred to herein as an electrical network). An asset of an electrical network may include, for example, one or more transmission lines, distribution stations, feeder lines, circuit spans, segments, poles, transformers, substations, towers, switches, relays, or the like (which may be referred to herein as electrical assets).

In various embodiments, the infrastructure monitoring system 104 may enhance, orient, and analyze (for example, using artificial intelligence (AI) or machine learning (ML) systems) geographic images to identify trees or vegetation in the images. In some embodiments, the infrastructure monitoring system 104 may estimate the heights of trees, their crown areas, their volumes, or their densities. The infrastructure monitoring system 104 may plot the vegetation (such as trees) on maps or provide shapefiles that include information regarding vegetation, such as the location, shape, and attributes of vegetation. Such shapefiles may be utilized in Geographic Information System (GIS) software.

In various embodiments, the infrastructure monitoring system 104 may request current satellite images from third parties, such as businesses or governments that operate imaging satellites, and utilize the images to identify vegetation. The infrastructure monitoring system 104 may request other satellite, airplane, helicopter, or drone images for the same geographic areas from the same or different data sources (for example, data sources 102A-102N), combine the images from different data sources for the same geographic areas and then analyze the information to identify potential threats to electrical assets or other information.

Utilizing satellite, airplane, helicopter, or drone images may provide significant advantages. For example, in addition to ease in obtaining the images, it will be appreciated that satellite images may have sufficient spatial resolution (for example, 30 centimeters (cm)×30 cm) for evaluating vegetation such as trees. The spatial resolution may refer to the size of a geographic area on the Earth represented by one pixel of the satellite image. For example, a 30 cm×30 cm spatial resolution may mean each pixel of the satellite image represents a 900 square centimeter area.

Different aerial or satellite images may have different spatial resolutions. In one example, a set of satellite images has a spatial resolution of 50 cm×50 cm. In some embodiments, satellite images have spatial resolutions other than 30 cm×30 cm and 50 cm×50 cm. The infrastructure monitoring system 104 may utilize satellite or aerial images that have spatial resolutions ranging from approximately 5 cm×5 cm to approximately 1 meter (m)×1 m. The infrastructure monitoring system 104 may receive images of the same area with different spatial resolutions. The infrastructure monitoring system 104 may modify certain satellite or aerial images to conform to a standard resolution. In some embodiments, the infrastructure monitoring system 104 may utilize artificial intelligence (AI) or machine learning (ML) techniques or models to improve the quality of captured images using histogram modification, contrast enhancement, or bilinear interpolation to generate high-resolution images from low-resolution images. For example, the infrastructure monitoring system 104 may utilize models such as a trained convolutional neural network (CNN) to improve the quality of captured images. Satellite images may be captured using red-green-blue (RGB) bands as well as an infrared (IR) band.

To account for the differences in image capture angles resulting from different forms of image capture, such as satellites, airplanes, helicopters, and drones, the infrastructure monitoring system 104 may receive images of the same area captured by different image capture methods. In some embodiments, the infrastructure monitoring system 104 may utilize images from different methods of image capture to correct for different image capture angles, enhance the information contained within the images, and add information for more accurate analysis. The infrastructure monitoring system 104 may utilize artificial intelligence or machine learning algorithms or models to correct the image capture angles, which may distort objects captured in the images.

In various embodiments, due to environmental factors such as cloud coverage, smoke, or fog, a satellite may require more than one flyover to capture satellite images, or an airplane, helicopter or drone may require more than one pass to capture aerial images of a particular area. The infrastructure monitoring system 104 may utilize artificial intelligence or machine learning algorithms or models to recognize features on each of the multiple images of the particular area. Similarly, the infrastructure monitoring system 104 may utilize artificial intelligence or machine learning algorithms or models, such as a CNN, to improve the quality of captured images by using contrast enhancement. In some embodiments, the infrastructure monitoring system 104 may receive satellite imagery of the same area over several years and use that information to estimate the growth of trees in that area and generate an estimate of a future schedule of vegetation management. Vegetation management may include any activity pertaining to vegetation proximate to utility assets, such as inspection, removal, and pruning.

In various embodiments, the infrastructure monitoring system 104 may correlate utility equipment or transmission line location information with images captured using various forms of image capture to identify an estimated location of electrical assets (for example, utility equipment or transmission lines). The infrastructure monitoring system 104 may receive this information from the infrastructure system 106. In one embodiment, the infrastructure monitoring system 104 may determine the location of transmission lines or utility equipment using feature recognition of an artificial intelligence or machine learning model.

The infrastructure system 106 may be responsible for the management, control, or alerts regarding a utility infrastructure. A utility infrastructure may be or include any network of infrastructure assets. For example, for an electrical utility, a utility infrastructure may be or include transmission lines, including electrical assets for the generation, transmission, and distribution of electricity. An electrical asset may be or include any component of the electrical network, including, for example, transmission lines, distribution stations, feeder lines, circuit spans, segments, poles, transformers, substations, towers, switches, relays, or the like. In some embodiments, the infrastructure system 106 may be operated by a utility company that owns the utility equipment or transmission lines, such as the Pacific Gas and Electricity Company (PG&E). It will be appreciated that there can be any number of infrastructure systems 106. Although FIG. 1 depicts an infrastructure system 106, it will be appreciated that there may not be an infrastructure system 106 but any system (or any number of different infrastructure systems management by any number of related or unrelated entities) that tracks or enables monitoring of infrastructure assets.

Although electrical networks may be specifically discussed herein, it will be appreciated that embodiments discussed herein may be applied to any infrastructure, including, for example, gas lines, pipelines, buildings, roads, highways, or the like.

In some embodiments, the communication network 108 may represent one or more computer networks (for example, LAN, WAN, or the like). The communication network 108 may provide communication between any of the data sources 102, the infrastructure monitoring system 104, and any of the infrastructure systems 106. In some implementations, the communication network 108 comprises computer devices, routers, cables, or other network topologies. In some embodiments, the communication network 108 may be wired or wireless. In various embodiments, the communication network 108 may comprise the Internet, one or more networks that may be public, private, IP-based, non-IP based, and so forth.

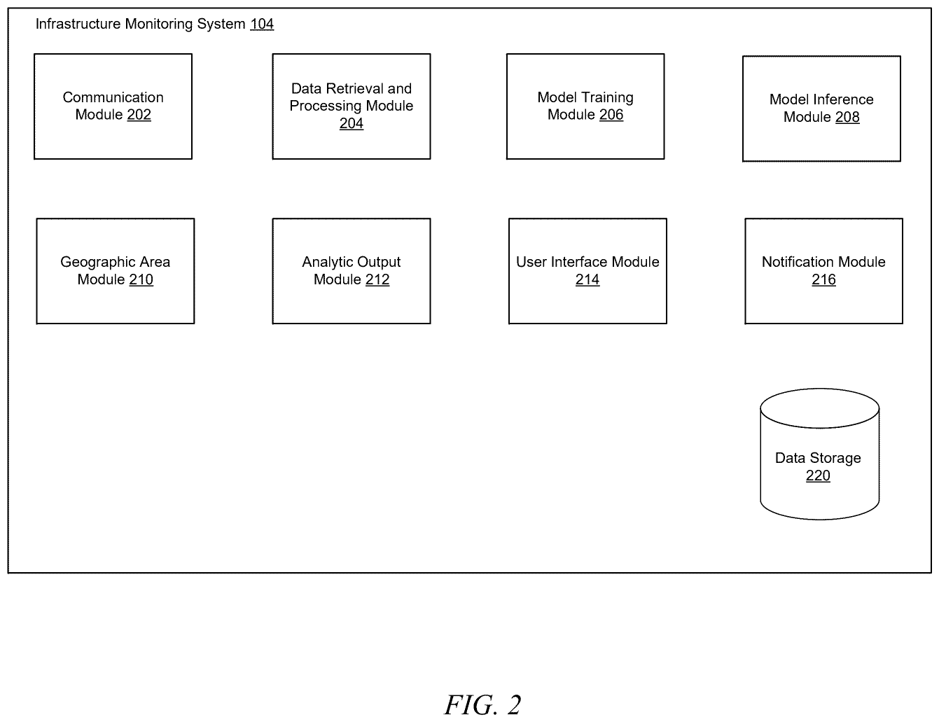

FIG. 2 depicts a block diagram of the infrastructure monitoring system 104 according to some embodiments. The infrastructure monitoring system 104 includes a communication module 202, a data retrieval and processing module 204, a model training module 206, a model inference module 208, a geographic area module 210, an analytic output module 212, a user interface module 214, a notification module 216, and a data storage 220.

The communication module 202 may send and receive requests or data between any of the data sources 102, the infrastructure monitoring system 104, and any of the infrastructure system 106. The communication module 202 may receive a request from a user of the infrastructure monitoring system 104 (for example, via an interface) to request data from a data source 102. In some embodiments, the communication module 202 may provide an interface or information for a remote interface to enable a third party (for example, a utility, a vegetation management company, workers, supervisors, contractors, insurance companies, or the like) to view and manage vegetation and other management activities relating to infrastructure assets.

In some embodiments, the data retrieval and processing module 204 may retrieve data from any number of data sources 102. In one example, a data source 102 may provide satellite, aerial or ground-level images, video, or other sensed data. The images, video, or other sensed data may be captured by different devices, such as satellites, airplanes, drones, image capture devices, surveillance cameras, and the like. As an example, commercially available satellite images from businesses that operate imaging satellites may provide a user interface or an Application Programming Interface (API) to download satellite images of specific geographic areas that the data retrieval and processing module 204 may utilize to obtain satellite images.

In various embodiments, the data retrieval and processing module 204 may interact with one or more of the data sources 102 to retrieve different images of the same geographic area or different geographic areas. For example, the data retrieval and processing module 204 may retrieve one set of images captured by satellite(s) of a geographic area that is available through one data source 102 and images and LiDAR data captured by an airplane of the same geographic area that is available through another data source 102. In some embodiments, the data retrieval and processing module 204 may request data based on a geographic area (for example, the coordinates of the geographic area), location information, date ranges, quality (for example, high quality or based on resolution), enhancement, orientation, or the like.

In various embodiments, the data retrieval and processing module 204 may utilize an API call to a software system that provides satellite images. In some embodiments, the data retrieval and processing module 204 may receive enhanced and aligned images from a satellite image source. In various embodiments, the data retrieval and processing module 204 may determine if images require enhancement. In some embodiments, the data retrieval and processing module 204 may utilize computer vision techniques and deep learning models to determine if the quality of images may be improved.

In some embodiments, the data retrieval and processing module 204 may optionally scan any number of images, remove noise, remove undesired markings provided by the service, improve accuracy, balance or remove color, or the like. In some embodiments, the spatial resolution of images captured by the different data sources 102 is different. The data retrieval and processing module 204 may utilize techniques such as histogram equalization, contrast enhancement, bilinear interpolation, or some combination thereof to generate high-resolution images from low-resolution images or to standardize image resolutions.

The data retrieval and processing module 204 may also process images to normalize intensity values of pixels of the images to a standard range. The data retrieval and processing module 204 may also process images by calculating various statistical measures of intensity values (for example, 50th percentile or 90th percentile of intensity values).

The model training module 206 may train one or more artificial intelligence (AI) or machine learning (ML) models. In some embodiments, the model training module 206 may train a fully convolutional neural network (which may also be referred to as a fully convolutional segmentation model). In embodiments where the one or more AI or ML models include one or more fully convolutional neural networks, the one or more fully convolutional neural networks may be based on a UNet architecture which includes an encoder and a decoder. The encoder may utilize a backbone (for example, ResNet50v2) that has been trained on images from an ImageNet dataset, which may include millions of images. The decoder may include five layers of a convolutional neural network that may be up sampled using nearest point interpolation. The model training module 206 may also train other models, such as sets of decision trees, that may be utilized to select data acquisition modalities for geographic sub-areas of a geographic area.

The model inference module 208 may perform inference on images for a geographic area using the one or more AI or ML models trained by the model training module 206. For example, the model inference module 208 may utilize a deep learning convolutional neural network (CNN) model which classifies pixels of an image as vegetation pixels or as non-vegetation pixels to perform inference. The model inference module 208 may also generate data structures as outputs of the inference. The model inference module 208 may also apply other models, such as trained sets of decision trees, to other data, such as satellite images, vegetation indicators derived from satellite images, and requirements data, to select data acquisition modalities for geographic sub-areas of a geographic area.

The geographic area module 210 may divide a geographic area (or a portion of a geographic area) into multiple geographic sub-areas. The geographic area module 210 may also locate infrastructure assets in geographic sub-areas. For example, the geographic area module 210 may utilize geographic data such as GIS shapefiles that include data on locations of infrastructure assets. The geographic area module 210 may utilize such geographic data and match features identified in satellite images, aerial images, or other sensed data to the infrastructure assets. The geographic area module 210 may thus georeference infrastructure assets in a common reference space, such as a common coordinate system.

In various embodiments, the analytic output module 212 may generate analytic outputs based on data captured by various data acquisition modalities for geographic areas or for infrastructure assets. The analytic output module 212 may also update analytic outputs when additional data captured by various data acquisition modalities is analyzed. For example, the analytic output module 212 may generate an analytic output for a geographic area based on satellite images captured for that geographic area. The model inference module 208 may select a different data acquisition modality for particular geographic sub-areas of the geographic area. After the infrastructure monitoring system 104 receives and analyzes data captured by the different data acquisition modality, the analytic output module 212 may generate a new analytic output based on the results of the data analysis or may update the existing analytic output. An analytic output may include a report, a dashboard, a visualization, or other generated content that may express the results of the analysis.

In some embodiments, the user interface module 214 may generate user interfaces that include geographic areas, infrastructure assets and the data acquisition modalities for the geographic areas. The notification module 216 may generate notifications of availability of analytic outputs or other analysis results. The notification module 216 may also provide notifications to systems such as the infrastructure systems 106.

In various embodiments, the data storage 220 includes data stored, accessed, or modified by any of the modules of the infrastructure monitoring system 104. The data storage 220 may be or include any data structures, such as tables, lists, databases, or any other structures.

A module of the infrastructure monitoring system 104 may be hardware, software, firmware, or any combination. For example, each module may include functions performed by dedicated hardware (for example, an Application-Specific Integrated Circuit (ASIC), a Field Programmable Gate Array (FPGA), or the like), software, instructions maintained in ROM, or any combination. Software may be executed by one or more processors. Although a limited number of modules are depicted in FIG. 2, there may be any number of modules. Further, individual modules may perform any number of functions, including functions of multiple modules as described herein.

FIG. 3C depicts an example architecture 350 of the infrastructure monitoring system 104 according to some embodiments. The architecture 350 may include three layers, such as a data acquisition layer 352, a data acquisition modality selection and data fusion layer 354, and an asset management layer 356.

The data acquisition layer 352 may be responsible for collecting diverse data including satellite imagery, aerial photography, unmanned aerial vehicle (UAV) imagery, vehicle-mounted camera streams, ground-based sensors, and other mapping datasets. The data acquisition layer 352 may incorporate multiple modalities including: (i) very high-resolution satellite imagery (30 cm-1 m), (ii) medium-resolution satellite imagery (1-5 m), (iii) aerial imaging platforms, (iv) UAV-based imaging systems, and (v) linear infrastructure-mounted imaging sensors.

The data acquisition modality selection and data fusion layer 354 may apply rule-based and machine learning-based decision logic to the data acquired by the data acquisition layer 352 to select the appropriate data acquisition modality and determine data acquisition frequency. For example, the data acquisition modality selection and data fusion layer 354 may determine the optimal data source based on asset type, geography, and accessibility, and may dynamically assign data acquisition cadence (daily, weekly, seasonal) depending on asset criticality and operational constraints. The data acquisition modality selection and data fusion layer 354 may also fuse multi-modal data to produce high-confidence asset information. For example, the data acquisition modality selection and data fusion layer 354 may perform data integration across modalities using statistical weighting, confidence scores, and ensemble fusion models to improve robustness and reduce uncertainty.

The asset management layer 356 may receive outputs from the data acquisition modality selection and data fusion layer 354 and utilize such outputs to provide actionable insights, such as predictive maintenance, regulatory compliance monitoring, anomaly detection, and vegetation risk assessment. For example, the asset management layer 356 may provide interfaces to enterprise systems and expose processed results for end-user applications. Example applications include monitoring of utility infrastructure, detection of encroachments or illegal constructions, forecasting vegetation risk, and generation of regulatory compliance reports.

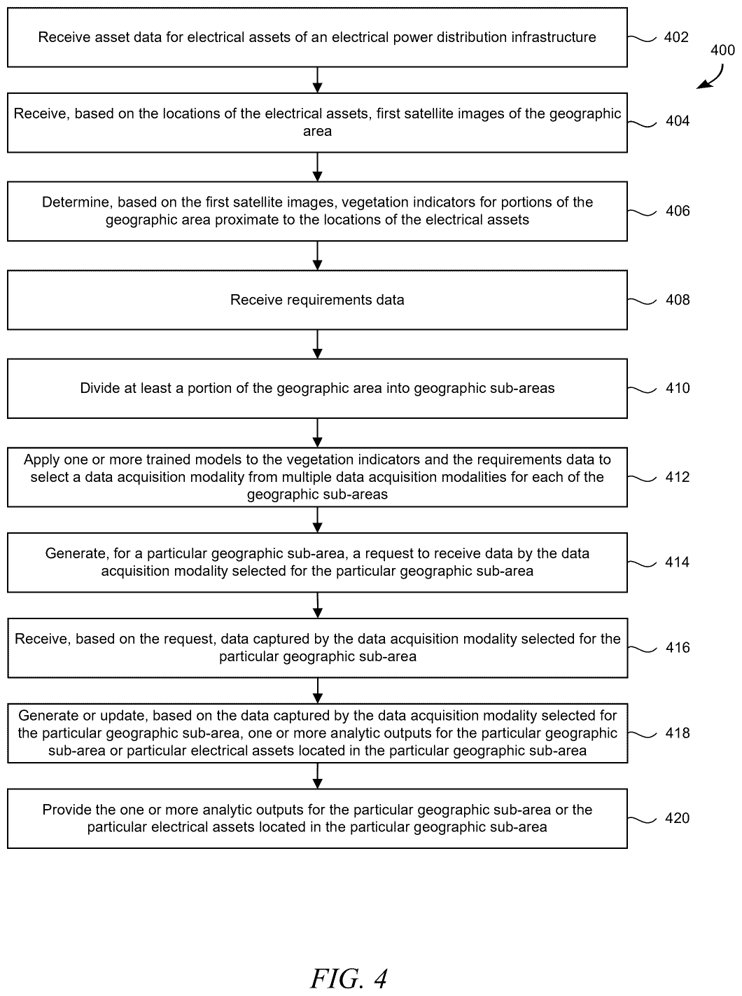

FIG. 4 is a flow diagram depicting a method 400 for selection and fusion of data acquisition modalities for infrastructure asset monitoring in some embodiments. The infrastructure monitoring system 104 (for example, various modules of the infrastructure monitoring system 104) may perform the method 400. The method 400 is described using the example of electrical assets of an electrical power distribution infrastructure, but it will be understood that the method 400 is applicable to other types of infrastructure assets.

The method 400 may begin at step 402 where the infrastructure monitoring system 104 (for example, the data retrieval and processing module 204) may receive asset data for electrical assets of an electrical power distribution infrastructure. The electrical assets may be located in a geographic area, and the asset data may include the locations of the electrical assets in the geographic area. For example, the data retrieval and processing module 204 may obtain geographic data such as GIS shapefiles that include data on the locations of the electrical assets in the geographic area.

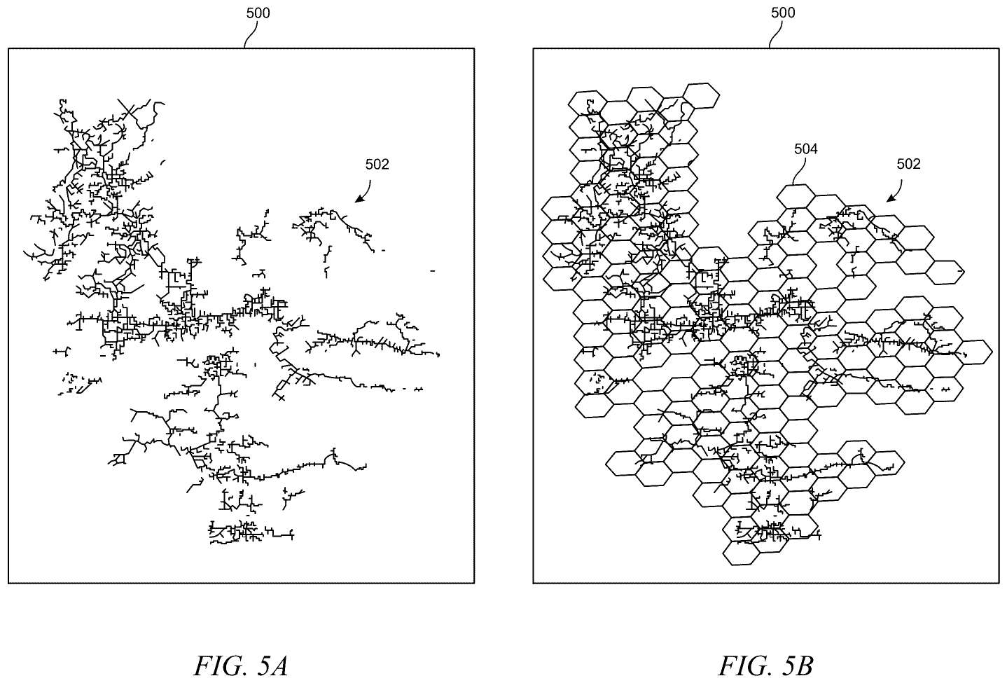

FIG. 5A is a diagram depicting example asset data for electrical assets of an electrical power distribution infrastructure located in a geographic area 500. The geographic area 500 includes an electrical power distribution infrastructure 502 that includes multiple electrical assets, such as transmission lines, distribution lines, substations, transformers, poles, towers, switches, relays, or other components that form part of an electrical power distribution infrastructure. The asset data for the electrical assets may include locations of the electrical assets within the geographic area 500, and may be received by the infrastructure monitoring system 104 as described herein. The asset data may be utilized to identify the spatial distribution and connectivity of the electrical assets within the geographic area, and may serve as a basis for further analysis, such as determining vegetation indicators or selecting data acquisition modalities for monitoring the electrical assets.

Returning to FIG. 4, at step 404 the infrastructure monitoring system 104 (for example, the data retrieval and processing module 204) may receive, based on the locations of the electrical assets, first satellite images of the geographic area, the first satellite images having a first resolution. For example, the first satellite images may have a first resolution of one (1) meter per pixel. In various embodiments, the first resolution is ten (10) meters per pixel.

At step 406 the infrastructure monitoring system 104 (for example, the data retrieval and processing module 204) may determine, based on the first satellite images, vegetation indicators for portions of the geographic area that include the electrical assets. For example, the infrastructure monitoring system 104 may determine a vegetation density indicator for the portions of the geographic area that include the electrical assets, such as the portions of the geographic area that are proximate to the electrical assets. Another example of a vegetation indicator that the infrastructure monitoring system 104 may determine is a distance from the vegetation to the electrical asset.

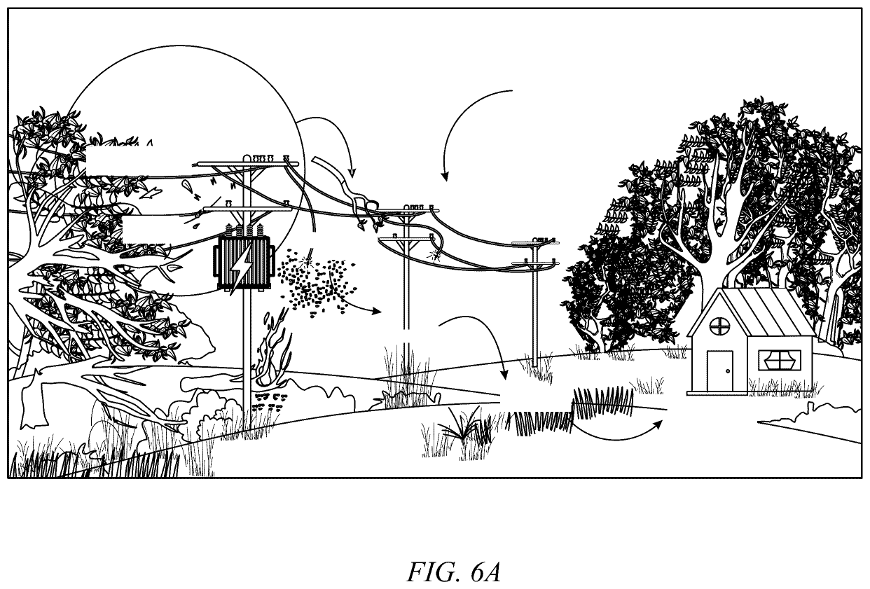

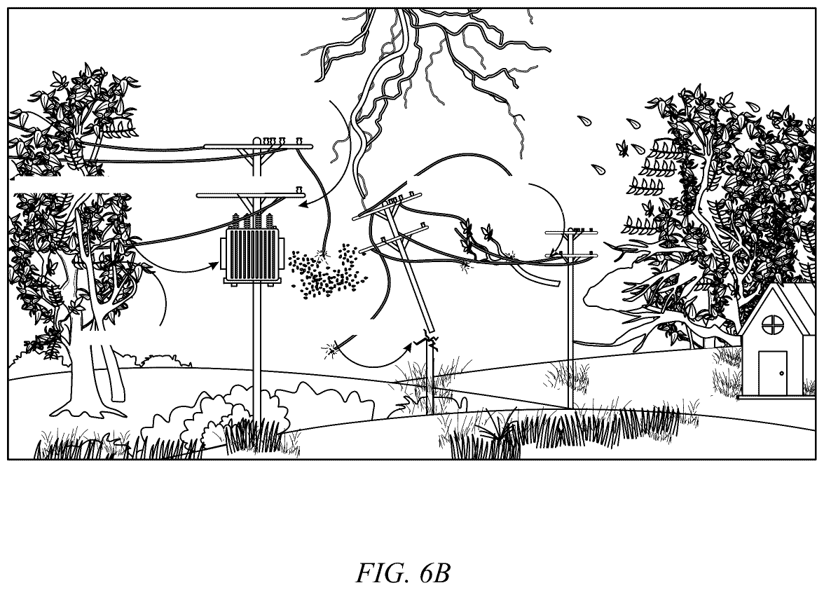

At step 408 the infrastructure monitoring system 104 (for example, the data retrieval and processing module 204) may receive requirements data that includes one or more requirements relating to the electrical assets or the geographic area. For example, the one or more requirements may relate to or include a wildfire risk assessment for the geographic area or a portion of the geographic area. FIG. 6A is a diagram depicting wildfire risk and the impact of wildfires on infrastructure assets according to some embodiments. FIG. 6A illustrates that wildfires may threaten infrastructure assets. As another example, the one or more requirements may relate to or include a hazard tree assessment for the geographic area or a portion of the geographic area. FIG. 6B is a diagram depicting hazard tree risk and the impact of hazard trees on utility assets in some embodiments. FIG. 6B illustrates that hazard trees may threaten infrastructure assets. As another example, the one or more requirements may relate to or include financial constraints or budget amounts relating to vegetation management for the electrical assets or the geographic area.

Returning to FIG. 4, at step 410 the infrastructure monitoring system 104 (for example, the geographic area module 210) may divide at least a portion of the geographic area into geographic sub-areas. FIG. 5B is a diagram depicting the geographic area 500 further divided into multiple geographic sub-areas 504 for analysis of the electrical assets. The geographic sub-areas 504 may be defined using any suitable spatial partitioning technique, such as a grid, hexagonal tessellation, or other division of the geographic area 500. The electrical power distribution infrastructure 502 is shown overlaid with the geographic sub-areas 504, illustrating how the infrastructure monitoring system 104 may divide at least a portion of the geographic area into geographic sub-areas for subsequent processing. The division into geographic sub-areas 504 enables the application of one or more trained models to select a data acquisition modality from multiple data acquisition modalities for each of the geographic sub-areas.

Returning to FIG. 4, at step 412 the infrastructure monitoring system 104 (for example, the model inference module 208) may apply one or more trained models to the vegetation indicators and the requirements data to select a data acquisition modality from multiple data acquisition modalities for each of the geographic sub-areas. In some embodiments, the multiple data acquisition modalities include one or more satellites configured to capture satellite data. The satellite data may include second satellite images. At least some of the second satellite images may have a second resolution different from the first resolution. In various embodiments, the second satellite images may have second resolutions ranging from ten (10) meters per pixel to ten (10) centimeters per pixel.

In some embodiments, the multiple data acquisition modalities may also include one or more aerial modalities configured to capture aerial data from the air, such as airplanes, helicopters, or drones. The aerial data may include one or more of images, LiDAR data, hyperspectral data, infrared data, ultraviolet data, or other sensor data. In some embodiments, the images in the aerial data may have resolutions ranging from fifteen (15) centimeters per pixel to five (5) centimeters per pixel. In various embodiments, the multiple data acquisition modalities may also include one or more surface modalities configured to capture surface data from the surface. The surface data may include one or more of images, LiDAR data, hyperspectral data, infrared data, ultraviolet data, or other sensor data.

The infrastructure monitoring system 104 may also apply the one or more trained models to the vegetation indicators and the requirements data to determine a frequency or timing of capture of the data acquisition modality. The vegetation indicators may also include one or more of vegetation densities or distances from vegetation to the electrical assets.

At step 414 the infrastructure monitoring system 104 (for example, the data retrieval and processing module 204) may generate, for a particular geographic sub-area, a request to receive data of the data acquisition modality selected for the particular geographic sub-area. For example, the infrastructure monitoring system 104 may request data from a data source 102 that may provide data captured by the selected data acquisition modality. At step 416 the infrastructure monitoring system 104 (for example, the data retrieval and processing module 204) may receive, based on the request, data captured by the data acquisition modality selected for the particular geographic sub-area. For example, the infrastructure monitoring system 104 may receive the requested data from the data source 102.

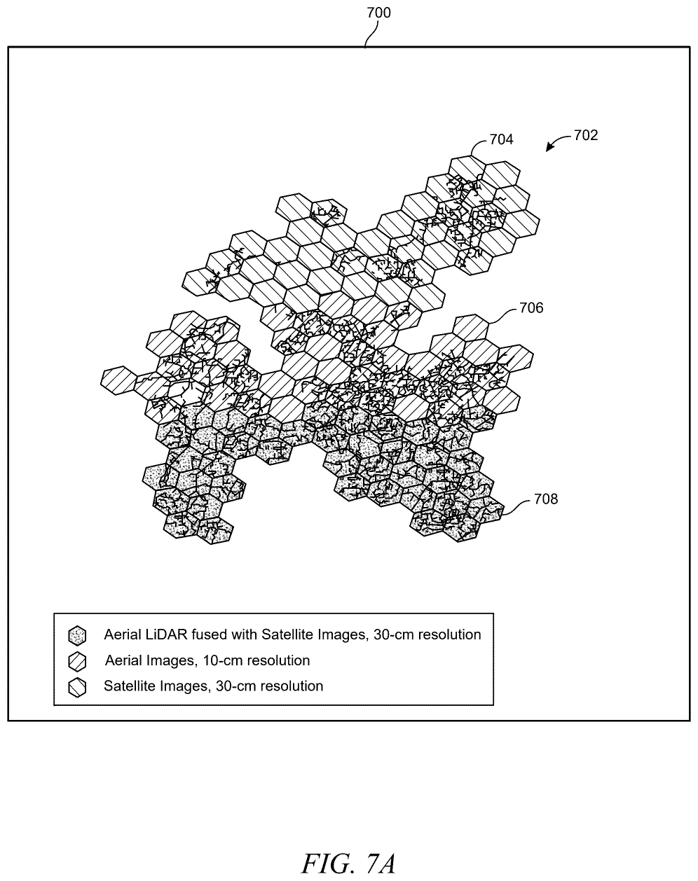

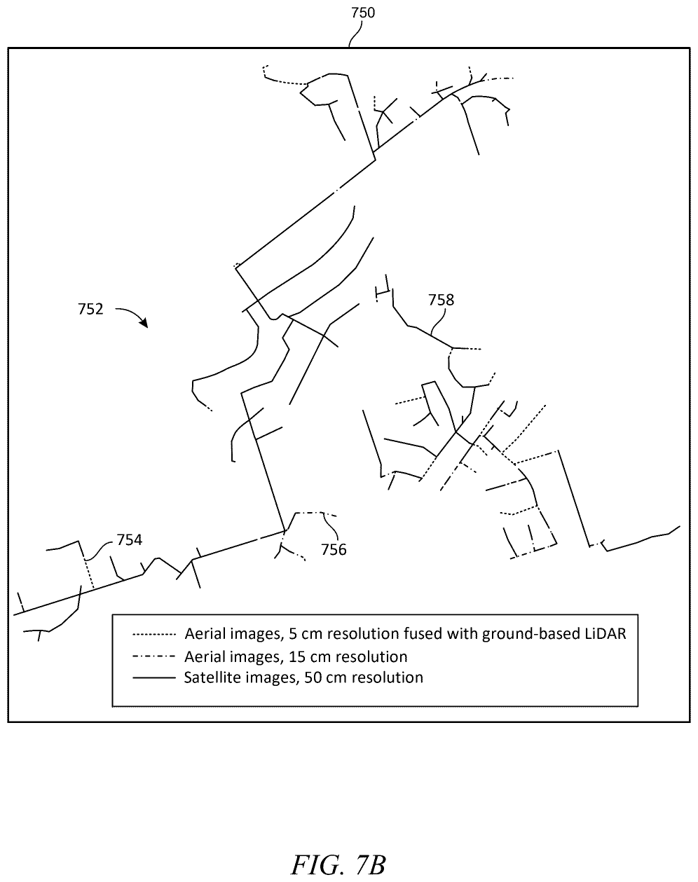

At step 418 the infrastructure monitoring system 104 (for example, the analytic output module 212) may generate or update, based on the data captured by the data acquisition modality selected for the particular geographic sub-area, one or more analytic outputs for the particular geographic sub-area or particular electrical assets located in the particular geographic sub-area. FIG. 7A is a diagram depicting an example analytic output 700 according to some embodiments. The analytic output 700 is for a geographic area 702 divided into multiple geographic sub-areas. The analytic output 700 depicts that for certain geographic sub-areas, such as the geographic sub-area 704, the selected data acquisition modality is satellite images having a 30 centimeters per pixel resolution. For other geographic sub-areas, such as the geographic sub-area 706, the selected data acquisition modality is aerial images having a 10 centimeters per pixel resolution. For still other geographic sub-areas, such as the geographic sub-area 708, the selected data acquisition modality is aerial LiDAR fused with satellite images having a 30 centimeters per pixel resolution.

FIG. 7B is a diagram depicting another example analytic output 750 in some embodiments. The analytic output 750 shows selected data acquisition modalities for segments of an electrical power distribution infrastructure 752. The analytic output 750 depicts that for certain segments of the electrical power distribution infrastructure 752, such as the segment 758, the selected data acquisition modality is satellite images having a 50 centimeters per pixel resolution. For other segments of the electrical power distribution infrastructure 752, such as the segment 756, the selected data acquisition modality is aerial images having a 15 centimeters per pixel resolution. For still other segments of the electrical power distribution infrastructure 752, such as the segment 754, the selected data acquisition modality is aerial images having a 5 centimeters per pixel resolution fused with ground-based LiDAR.

Returning to FIG. 4, at step 420 the infrastructure monitoring system 104 (for example, the notification module 216) may provide the one or more analytic outputs for the particular geographic sub-area or the particular electrical assets located in the particular geographic sub-area. For example, the infrastructure monitoring system 104 may provide the one or more analytic outputs to an infrastructure system 106.

In various embodiments, the one or more analytic outputs are one or more second analytic outputs. The infrastructure monitoring system 104 may also have previously generated, based on the vegetation indicators, one or more first analytic outputs. The infrastructure monitoring system 104 may update the one or more first analytic outputs for the particular geographic sub-area or the particular electrical assets located in the particular geographic sub-area with the data captured by the data acquisition modality selected for the particular geographic sub-area to generate the one or more second analytic outputs.

In some embodiments, the infrastructure monitoring system 104 may receive additional data and apply the one or more trained models to the additional data to select a data acquisition modality for a geographic sub-area. For example, the infrastructure monitoring system 104 may receive building data for the geographic area that includes one or more locations of one or more buildings in the geographic area, terrain data for the geographic area that includes land use and land cover data for the geographic area, or slope data that is sourced from Digital Terrain Models (DTMs), such as SRTM. As another example, the infrastructure monitoring system 104 may receive historical wildfire data for the geographic area that includes portions of the geographic area affected by historical wildfires, historical outage data for the electrical assets, that includes the electrical assets affected by historical outages, or weather data for the geographic area that includes one or more of historical weather data for the geographic area or forecasted weather data for the geographic area. The infrastructure monitoring system 104 may also receive vegetation management data that includes historical vegetation management activities proximate to the electrical assets.

In some embodiments, the one or more trained models output two scores. The first score may be referred to as the res-granularity score and may indicate whether an area requires detailed, critical analysis or can be analyzed using more generic, less detailed methods. As an example, for one geographic sub-area, a high res-granularity score may indicate that the geographic sub-area is important and therefore requires a high level of detailed analysis, which will be conducted using LiDAR data. Conversely, in another geographic sub-area with a low res-granularity score, the area may be effectively analyzed using lower resolution data, such as satellite images with resolutions of 50 cm or 1 meter.

The second score may be referred to as the freq-granularity score and may indicate the frequency with which data should be acquired by data acquisition modalities. For example, the freq-granularity score may indicate whether the data acquisition should occur bi-yearly, yearly, once every three years, once every five years, or at other intervals. As an example, for a geographic sub-area with a high freq-granularity score, annual analysis may be recommended. In contrast, a geographic sub-area with a low freq-granularity score may only require periodic analysis (for example, every four to five years). It will be appreciated that there may be any number of scores regarding different aspects of granularity.

Examples are now described.

### Example 1—Adaptive Data Acquisition Modality and Cadence Selection in a Desert Utility Network

The operational context is that a transmission and distribution network traverses two distinct environments within a desert region: 1) sparsely vegetated desert corridors along highways and rights-of-way (ROWs); and 2) an urbanized enclave inside the same region with roadside trees and landscaped vegetation proximate to overhead conductors.

One objective of the utility is to reduce or minimize monitoring cost while meeting safety and reliability constraints by selecting the least costly data acquisition modality and lowest safe acquisition cadence for each zone, subject to risk tolerances defined by the utility.

The infrastructure monitoring system 104 computes a span-level hazard index R that drives both modality selection and acquisition cadence. R is a weighted function of proximity-to-conductor, vegetation growth rate, asset criticality, and anecdotal knowledge from prior inferences. In some cases, R is computed according to the following formula:

$$R = w\_prox * f\_prox ( distance\_to \_conductor ) + w\_growth * f\_growth ( expected\_growth \_rate ) + w\_crit * f\_crit ( asset\_criticality ) + w\_unc * f\_unc ( model\_uncertainty )$$

In some cases, acquisition cadence is given by the following formula. A higher R or uncertainty_band may result in a higher acquisition cadence.

$$acquisition cadence = g ( R , uncertainty\_band )$$

In some cases, the data acquisition modality is given by the following formula, where a total_cost (m) is subject to performance (m)>threshold (R):

$$modality = arg min \_ \{ m in M \}$$

Performance (m) encapsulates detection/measurement error bounds (for example, planimetric accuracy, canopy edge localization, minimum detectable object size), while total_cost (m) captures data cost, collection logistics, and processing time. Threshold (R) tightens with higher risk (for example, smaller allowable miss distance near conductors).

In Zone A, which includes sparse desert corridors, and has low vegetation density, the evidence inputs may be: (1) trees detected in low resolution satellite images, and lower values of vegetation indices and canopy density from prior scenes; (2) historical growth models indicating slow vegetation accretion; (3) minimal spans with vegetation within operational clearance buffers; and (4) low occlusion risk (flat terrain, open ROW). The infrastructure monitoring system 104 selects low-resolution satellite imagery (˜50 cm GSD) with a low acquisition cadence (˜once every two years). The selection may be justified by the following factors: coverage efficiency: wide-area satellites provide complete network coverage without tasking aerial imagery; adequate spatial fidelity: 50 cm GSD meets the minimum detection requirement given large separations between vegetation and conductors; low expected change: empirical growth models forecast negligible canopy encroachment within the review window; favorable illumination/occlusion: desert corridors exhibit low shadowing and clutter; lower SNR is acceptable; and cost and logistics: lowest cost per km²; minimal operational overhead; rapid availability.

In Zone B which includes an urban enclave, and has higher vegetation density near conductors, the evidence inputs may be: (1) pre-screening by fusion model marks elevated vegetation density; (2) field constraints show ˜20% of spans with vegetation within critical proximity thresholds; (3) increased occlusion from buildings and street trees; and (4) higher outage/safety impact. The infrastructure monitoring system 104 selects high-resolution aerial imagery (˜10 cm GSD) with a higher cadence (˜annual collection). The selection may be justified by the following factors: spatial precision: 10 cm GSD provides conductor-to-vegetation separation estimates within required tolerances; occlusion handling: off-nadir multi-pass aerial collects reduce façade/overhang occlusions in urban canyons; dynamic change: annual cycle addresses faster growth and maintenance interventions near spans; risk-weighted thresholds: higher R enforces stricter performance constraints; satellite-only solutions underperform these threshold; and latency control: aircraft scheduling provides timely collections aligned to maintenance windows.

The following table describes a data acquisition modality matrix.

TABLE 1

| | Low-Res Satellite | High-Res Aerial | |
|---|---|---|---|
| Decision Factor | (Zone A) | (Zone B) | Rationale |
| Vegetation density/ | Low; homogeneous | Moderate-High; | Higher density near |
| low res detected | | heterogeneous | conductors requires |
| trees | | | finer GSD |
| Expected growth | Slow; low variance | Faster; pruning | Cadence tied to |
| rate | | cycles evident | modeled growth |
| Proximity to | Sparse | ≈20% spans near | Tighter error |
| conductors | encroachment | threshold | bounds needed in |
| | | | Zone B |
| Occlusion risk | Minimal | Elevated | Aerial multi-pass |
| | | (buildings/trees) | mitigates occlusion |
| Coverage need | Network-wide, low | Targeted corridors | Allocate costly |
| | cost | | modalities to |
| | | | hotspots |
| Latency/revisit | Routine, low | Scheduled annual | Align with |
| | cadence | windows | maintenance SLAs |
| Cost per km² | Lowest | Higher | Budget to risk |
| | | | weighting |
| Required accuracy | Moderate | High | Meets Threshold(R) |
| | | (conductor-clearance) | in each zone |
| Uncertainty | Low epistemic | Higher; reduced via | Cadence increases |
| | uncertainty | HR data | with uncertainty |
| Resulting cadence | ~24 months | ~12 months | g(R, uncertainty) |
| | | | mapping |

The infrastructure monitoring system 104 may reevaluate R after each collection and upon external triggers (for example, storms, fire seasons, rapid growth alerts). If R crosses policy thresholds or the uncertainty band widens, the cadence may be escalated, or the data acquisition modality may be upgraded for subsequent cycles.

### Example 2—LiDAR and High-Resolution Satellite Fusion for Hazard Tree Identification in Feeder Corridors

The operational context is electric feeder corridors in mixed forest environments. Such an operational context requires not only knowledge of vegetation encroachment into conductor clearances, but also the ability to detect hazard trees-trees that may fail due to poor health, structural weakness, or shallow rooting and fall into the right-of-way. Traditional 2D imagery alone may be insufficient, as it may fail to reveal canopy height, vertical understory competition, or crown depth. Conversely, LiDAR point clouds provide rich 3D geometry but limited spectral or textural cues of vegetation health. To overcome these limitations, the infrastructure monitoring system 104 may fuse airborne LiDAR data with very-high-resolution (30 cm GSD) satellite imagery to produce a unified hazard assessment map.

One objective is to provide a fused vegetation risk layer that simultaneously captures: 1) tree heights and canopy structure (from LiDAR); 2) vegetation understory density (LiDAR vertical profile); 3) vegetation health and hazard indicators (satellite spectral/textural features); and 4) relative proximity to conductors (from asset corridor data). This output may enable utilities to prioritize hazard tree removals and targeted trimming beyond simple clearance-based rules.

Data sources may include 1) airborne LiDAR (point cloud or DSM or DTM) from which canopy height model (CHM), understory density maps, crown depth and lean angle of tall trees, and other information may be derived; 2) high-resolution satellite imagery (30 cm resolution, RGB+NIR), from which vegetation texture features (for example, edge roughness, canopy gaps), spectral health indices (NDVI, NBR) to detect stress or mortality, and other information may be derived; and 3) grid asset data (feeder corridor geometries) such as conductor locations, pole spans, and buffer distances.

The infrastructure monitoring system 104 may perform several operations to provide the fused vegetation risk layer. A first operation may include processing the airborne LiDAR data to classify ground vs. non-ground returns, generate canopy height model (CHM) at 1 m resolution, and compute the understory density (vertical distribution of returns below main canopy, such as small trees under big trees). A second operation may include processing satellite data to segment vegetation patches at 30 cm GSD and to derive texture statistics to tell unhealthy vegetation. A third operation may include co-registration of the LiDAR data and the satellite image data. The infrastructure monitoring system 104 may resample LiDAR-derived features to 30 cm grid and align satellite and LiDAR datasets using ground control and RPC models.

The outputs of the infrastructure monitoring system 104 may include classification of trees or other vegetation into one of several tiers: 1) tier 1 hazard trees, which may be tall, stressed, and leaning trees within fall radius of conductors, thereby presenting a high risk; 2) tier 2 hazard trees, which may be healthy but have tall understory competition, and within defined proximity of utility assets, thereby presenting a moderate risk; and 3) short, healthy vegetation or distant trees, thereby presenting a low risk. The infrastructure monitoring system 104 may recommend immediate removal for tier 1 hazard trees, prioritized monitoring for tier 2 hazard trees, and routine monitoring for trees in the low risk classification.

Justification and advantages of this approach may include the following: 3D+spectral fusion: captures both structural vulnerability and biological stress; improved detection of hazard trees: LiDAR height maps highlight tall crowns, while satellite health indices flag stressed crowns likely to fail; understory insight: LiDAR penetration reveals suppressed vegetation layers that could emerge as hazard trees after canopy removal; and cost efficiency: LiDAR may be acquired less frequently (for example, every 3 years) while satellite provides annual refreshes, with the fusion model maintaining updated hazard scores.

### Example 3—Year-over-Year Modality Downgrade Under Reduced Vegetation Strike Risk

The operation context may be that a feeder corridor runs through mixed suburban land cover with seasonal growth. In Year 1, the utility tasks high-resolution aerial imagery (˜10 cm GSD) to baseline canopy-to-conductor distances and build a calibrated vegetation-risk model. In Year 2, the system reassesses risk using updated evidence (growth modeling, maintenance records, and weather) and—if risk is sufficiently low and uncertainty narrow—downgrades to lower-resolution satellite (˜50 cm GSD) to reduce cost while meeting safety thresholds.

One objective is to reduce or minimize total monitoring cost in Year 2 while guaranteeing that measurement performance (clearance estimation error, minimum detectable canopy encroachment) remains≥the required safety threshold given the current risk level and uncertainty.

Data inputs may include the following: 1) Year 1 HR (high resolution) aerial (10 cm), from which baseline canopy polygons, offsets to phase conductors, conductor sag profiles, confidence intervals, and other information may be derived; 2) a vegetation growth model: species-/climate-aware growth rate; pruning/trim cycles; disturbance history (storms, fires); 3) maintenance/work records: completed trims and window-clearance targets; 4) weather/climate summary: precipitation, drought index, wind regime, heat days; changes year over year; and 5) asset criticality: feeder importance, fault impact score, customers served.

The year-over-year evidence and decision may include the following: Year 1 (baseline —HR aerial at 10 cm resolution): 1) 95% of spans exhibit≥2.5 m clearance; 2) encroachment hot-spots corrected by targeted trims; and 3) confidence intervals≤0.25 m on clearance estimates. The action may be that HR aerial is chosen to build a trusted baseline.

In Year 2, re-assessment may occur. The evidence inputs may include: 1) the growth model predicts median regrowth≤0.4 m; 2) trimming logs confirm high-priority spans serviced; 3) no extreme drought/heat anomalies; storm season mild; and 4) asset criticality unchanged. The decision may be that the data acquisition modality for the low-risk 88% of spans is to downgrade to LR (low resolution) satellite (50 cm-1 meter) and use an annual cadence. For the medium-risk 12%, the decision may be that the data acquisition modality is HR aerial or task targeted LiDAR/aerial just for those corridors. One outcome may include significant cost reduction by applying HR imaging only to a small subset of utility assets and LR imaging to the majority of utility assets.

The infrastructure monitoring system 104 may facilitate performance and safeguards by utilizing LR satellite (50 cm) so as to still detect canopy expansions ≥ ˜1-1.5 m at corridor scale, which should be sufficient when clearance margins remain >2 m, and by utilizing HR aerial where minimum detectable encroachment must be≤0.5 m.

### Example 4—Local-Level Data Fusion for Wildfire Risk Assessment

The operation context may be that a distribution network traverses a wildfire-prone forest corridor in a mountainous region. The asset owner's concern is not just vegetation encroachment into conductors, but also the compound wildfire hazard created by vegetation load, topographic slope/aspect, and climate conditions.

One objective is to fuse multiple modalities covering the same corridor to estimate: 1) vegetation fuel load and distribution (potential combustible material); 2) wildfire spread potential (driven by slope, aspect, terrain connectivity); and 3) wildfire ignition likelihood (based on weather conditions such as temperature, humidity, wind speed/direction). The fusion output may drive proactive asset hardening and vegetation clearance programs

Data sources include the following: 1) mid/high-resolution satellite imagery (30-50 cm GSD), from which the infrastructure monitoring system 104 may extract vegetation extent, canopy cover, and classify land cover (fuel vs non-fuel); 2) digital surface models (DSM) or digital elevation models (DEM), from which the infrastructure monitoring system 104 may derive slope and aspect for each span segment (which may be important as steeper slopes may accelerate wildfire spread; south/west-facing slopes (in northern hemisphere) may have higher exposure/dryness); 3) meteorological and climate data, such as weather stations and reanalysis datasets, variables: temperature, relative humidity, wind speed/direction, and drought index (which may be important as these factors relate to ignition potential and spread directionality (wind-driven)); and 4) asset data and grid topology, such as location of poles, conductors, and substations, and a criticality weighting: higher risk tolerance around transmission corridors feeding major substations.

Justification and advantages of this approach may include the following: 1) complementary strengths, as satellite imagery provides horizontal canopy detail, DSM adds 3D terrain, weather contextualizes ignition risk; 2) granularity, as the same corridor is analyzed from multiple perspectives, which may lead to robust hazard mapping; and 3) actionability: output directly informs both vegetation management and wildfire contingency planning.

FIG. 8 depicts a block diagram of an example digital device 800 according to some embodiments. The digital device 800 is shown in the form of a general-purpose computing device. The digital device 800 includes at least one processor 802, which may be or include one or more central processing units (CPUs) or one or more graphics processing units (GPUs), random access memory (RAM 804), communication interface 806, input/output device 808, storage 810, and a system bus 812 that couples various system components including storage 810 to the at least one processor 802. A set (which may be a physical set or a logical set) of one or more of the digital device 800 may be referred to as a computing system.

System bus 812 represents one or more of any of several types of bus structures, including a memory bus or memory controller, a peripheral bus, an accelerated graphics port, and a processor or local bus using any of a variety of bus architectures. By way of example, and not limitation, such architectures include Industry Standard Architecture (ISA) bus, Micro Channel Architecture (MCA) bus, Enhanced ISA (EISA) bus, Video Electronics Standards Association (VESA) local bus, and Peripheral Component Interconnect (PCI) bus.

The digital device 800 typically includes a variety of computer system readable media, such as computer system readable storage media. Such media may be any available media that is accessible by any of the systems described herein and it includes both volatile and nonvolatile media, removable and non-removable media.

In some embodiments, the at least one processor 802 is configured to execute executable instructions (for example, programs). In some embodiments, the at least one processor 802 comprises circuitry or any processor capable of processing the executable instructions.

In some embodiments, RAM 804 stores programs or data. In various embodiments, working data is stored within RAM 804. The data within RAM 804 may be cleared or ultimately transferred to storage 810, such as prior to reset or powering down the digital device 800.

In some embodiments, the digital device 800 is coupled to a network via communication interface 806. The digital device 800 can communicate with one or more networks such as a local area network (LAN), a general wide area network (WAN), or a public network (for example, the Internet).

In some embodiments, input/output device 808 is any device that inputs data (for example, mouse, keyboard, stylus, sensors, etc.) or outputs data (for example, speaker, display, virtual reality headset).

In some embodiments, storage 810 can include computer system readable media in the form of non-volatile memory, such as read only memory (ROM), programmable read only memory (PROM), solid-state drives (SSD), flash memory, or cache memory. Storage 810 may further include other removable/non-removable, volatile/non-volatile computer system storage media. By way of example only, storage 810 can be provided for reading from and writing to a non-removable, non-volatile magnetic media. The storage 810 may include a non-transitory computer-readable medium, or multiple non-transitory computer-readable media, which stores programs or applications for performing functions such as those described herein. Although not shown, a magnetic disk drive for reading from and writing to a removable, non-volatile magnetic disk (for example, a “floppy disk”), and an optical disk drive for reading from or writing to a removable, non-volatile optical disk such as a CDROM, DVD-ROM or other optical media can be provided. In such instances, each can be connected to system bus 812 by one or more data media interfaces. As will be further depicted and described below, storage 810 may include at least one program product having a set (for example, at least one) of program modules that are configured to carry out the functions of embodiments of the technology. In some embodiments, RAM 804 is found within storage 810.

Programs/utilities, having a set (at least one) of program modules may be stored in storage 810 by way of example, and not limitation, as well as an operating system, one or more application programs, other program modules, and program data. Each of the operating system, one or more application programs, other program modules, and program data or some combination thereof, may include an implementation of a networking environment. Program modules generally carry out the functions or methodologies of embodiments of the technology as described herein.

It should be understood that although not shown, other hardware or software components could be used in conjunction with the digital device 800. Examples include, but are not limited to microcode, device drivers, redundant processing units, and external disk drive arrays, RAID systems, tape drives, and data archival storage systems, etc.

Exemplary embodiments are described herein in detail with reference to the accompanying drawings. However, the present disclosure can be implemented in various manners, and thus should not be construed to be limited to the embodiments disclosed herein. On the contrary, those embodiments are provided for the thorough and complete understanding of the present disclosure, and completely conveying the scope of the present disclosure.

It will be appreciated that aspects of one or more embodiments may be embodied as a system, method, or computer program product. Accordingly, aspects may take the form of an entirely hardware embodiment, an entirely software embodiment (including firmware, resident software, micro-code, etc.) or an embodiment combining software and hardware aspects that may all generally be referred to herein as a circuit, module or system. Furthermore, aspects may take the form of a computer program product embodied in one or more computer readable medium(s) having computer readable program code embodied thereon.

Any combination of one or more computer readable medium(s) may be utilized. The computer readable medium may be a computer readable signal medium or a computer readable storage medium. A computer readable storage medium may be, for example, but not limited to, an electronic, magnetic, optical, electromagnetic, infrared, or semiconductor system, apparatus, or device, or any suitable combination of the foregoing. More specific examples (a non-exhaustive list) of the computer readable storage medium would include the following: an electrical connection having one or more wires, a portable computer diskette, a hard disk, a random access memory (RAM), a read-only memory (ROM), an erasable programmable read-only memory (EPROM or Flash memory), a solid state drive (SSD), an optical fiber, a portable compact disc read-only memory (CD-ROM), an optical storage device, a magnetic storage device, or any suitable combination of the foregoing. In the context of this document, a computer readable storage medium may be any tangible medium that can contain or store a program or data for use by or in connection with an instruction execution system, apparatus, or device.

A transitory computer readable signal medium may include a propagated data signal with computer readable program code embodied therein, for example, in baseband or as part of a carrier wave. Such a propagated signal may take any of a variety of forms, including, but not limited to, electro-magnetic, optical, or any suitable combination thereof.

Program code embodied on a computer readable medium may be transmitted using any appropriate medium, including but not limited to wireless, wireline, optical fiber cable, RF, etc., or any suitable combination of the foregoing.

Computer program code for carrying out operations for aspects of the present technology may be written in any combination of one or more programming languages, including an object-oriented programming language such as Java, Smalltalk, C++, Python, or the like and conventional procedural programming languages, such as the C programming language or similar programming languages. The computer program code may execute entirely on any of the systems described herein or on any combination of the systems described herein.

Aspects of the present technology may be described with reference to flowchart illustrations or block diagrams of methods, apparatus (systems) and computer program products according to embodiments of the technology. It will be understood that each block of the flowchart illustrations or block diagrams, and combinations of blocks in the flowchart illustrations or block diagrams, can be implemented by computer program instructions. These computer program instructions may be provided to a processor of a general-purpose computer, special purpose computer, or other programmable data processing apparatus to produce a machine, such that the instructions, which execute via the processor of the computer or other programmable data processing apparatus, create means for implementing the functions/acts specified in the flowchart or block diagram block or blocks.

These computer program instructions may also be stored in a computer readable medium that can direct a computer, other programmable data processing apparatus, or other devices to function in a particular manner, such that the instructions stored in the computer readable medium produce an article of manufacture including instructions which implement the function/act specified in the flowchart or block diagram block or blocks.

The computer program instructions may also be loaded onto a computer, other programmable data processing apparatus, or other devices to cause a series of operational steps to be performed on the computer, other programmable apparatus or other devices to produce a computer implemented process such that the instructions which execute on the computer or other programmable apparatus provide processes for implementing the functions/acts specified in the flowchart or block diagram block or blocks.

While particular elements, embodiments and applications have been shown and described, it will be understood, of course, that the claims are not limited thereto since modifications may be made by those skilled in the art without departing from the spirit and scope of the present disclosure, particularly in light of the foregoing teachings. Such modifications are to be considered within the purview and scope of the claims appended hereto.

While specific examples are described above for illustrative purposes, various equivalent modifications are possible. For example, while processes or blocks are presented in a given order, alternative implementations may perform routines having steps, or employ systems having blocks, in a different order, and some processes or blocks may be deleted, moved, added, subdivided, combined, or modified to provide alternative or sub-combinations. Each of these processes or blocks may be implemented in a variety of different ways. Also, while processes or blocks are at times shown as being performed in series, these processes or blocks may instead be performed or implemented concurrently or in parallel or may be performed at different times. Further any specific numbers noted herein are only examples: alternative implementations may employ differing values or ranges.

Throughout this specification, plural instances may implement components, operations, or structures described as a single instance. Structures and functionality presented as separate components in example configurations may be implemented as a combined structure or component. Similarly, structures and functionality presented as a single component may be implemented as separate components. These and other variations, modifications, additions, and improvements fall within the scope of the subject matter herein. Furthermore, any specific numbers noted herein are only examples: alternative implementations may employ differing values or ranges.

Components may be described or illustrated as contained within or connected with other components. Such descriptions or illustrations are only examples, and other configurations may achieve the same or similar functionality. Components may be described or illustrated as “coupled,” “couplable,” “operably coupled,” “communicably coupled” and the like to other components. Such description or illustration should be understood as indicating that such components may cooperate or interact with each other, and may be in direct or indirect physical, electrical, or communicative contact with each other.

Components may be described or illustrated as “configured to,” “adapted to,” “operative to,” “configurable to,” “adaptable to,” “operable to” and the like. Such description or illustration should be understood to encompass components both in an active state and in an inactive or standby state unless required otherwise by context.

The use of “or” in this disclosure is not intended to be understood as an exclusive “or.” Rather, “or” is to be understood as including “and/or.” For example, the phrase “providing products or services” is intended to be understood as having several meanings: “providing products,” “providing services,” and “providing products and services.”

Headings in this application may be provided for organization and may not necessarily be used to interpret or constrain the purview and scope of the claims appended hereto. Moreover, concepts or features of technologies described under a particular heading may be used in technologies described under other headings. Accordingly, technologies described under a particular heading are not limited to the concepts or features described under that particular heading.

It may be apparent that various modifications may be made, and other embodiments may be used without departing from the broader scope of the discussion herein. Therefore, these and other variations upon the example embodiments are intended to be covered by the disclosure herein.

1. A non-transitory computer-readable medium comprising executable instructions, the executable instructions being executable by one or more processors to perform a method, the method comprising:
receiving asset data for electrical assets of an electrical power distribution infrastructure, the electrical assets located in a geographic area, the asset data including locations of the electrical assets in the geographic area;
receiving, based on the locations of the electrical assets, first satellite images of the geographic area, the first satellite images having a first resolution;
determining, based on the first satellite images, vegetation indicators for portions of the geographic area that include the electrical assets;
receiving requirements data, the requirements data including one or more requirements relating to the electrical assets or the geographic area;
dividing at least a portion of the geographic area into geographic sub-areas;
applying one or more trained models to the vegetation indicators and the requirements data to select a data acquisition modality from multiple data acquisition modalities for each of the geographic sub-areas, the multiple data acquisition modalities including:
one or more satellites configured to capture satellite data, the satellite data including second satellite images, at least some of the second satellite images having a second resolution different from the first resolution,
one or more aerial modalities configured to capture aerial data from the air, the aerial data including one or more of images, LiDAR data, hyperspectral data, infrared data, ultraviolet data, or other sensor data, and
one or more surface modalities configured to capture surface data from the surface, the surface data including one or more of images, LiDAR data, hyperspectral data, infrared data, ultraviolet data, or other sensor data;
generating, for a particular geographic sub-area, a request to receive data of the data acquisition modality selected for the particular geographic sub-area;
receiving, based on the request, data captured by the data acquisition modality selected for the particular geographic sub-area;
generating or updating, based on the data captured by the data acquisition modality selected for the particular geographic sub-area, one or more analytic outputs for the particular geographic sub-area or particular electrical assets located in the particular geographic sub-area; and
providing the one or more analytic outputs for the particular geographic sub-area or the particular electrical assets located in the particular geographic sub-area.

2. The non-transitory computer-readable medium of claim 1 wherein the one or more trained models are also applied to the vegetation indicators and the requirements data to determine a frequency or timing of capture of the data acquisition modality.

3. The non-transitory computer-readable medium of claim 1 wherein the one or more analytic outputs are one or more second analytic outputs, and the method further comprises generating, based on the vegetation indicators, one or more first analytic outputs, wherein generating or updating the one or more analytic outputs for the particular geographic sub-area or the particular electrical assets located in the particular geographic sub-area includes updating, further based on the one or more second analytic outputs, the one or more first analytic outputs.

4. The non-transitory computer-readable medium of claim 1 wherein the vegetation indicators include one or more of vegetation densities or distances from vegetation to the electrical assets.

5. The non-transitory computer-readable medium of claim 1 wherein the one or more requirements include a wildfire risk assessment for the geographic area, and the one or more analytic outputs include the wildfire risk assessment for the particular geographic sub-area.

6. The non-transitory computer-readable medium of claim 1 wherein the one or more requirements include a hazard tree assessment for the geographic area, and the one or more analytic outputs include the hazard tree assessment for the particular geographic sub-area.

7. The non-transitory computer-readable medium of claim 1, the method further comprising:
receiving building data for the geographic area, the building data including one or more locations of one or more buildings in the geographic area; and
receiving terrain data for the geographic area, the terrain data including land use and land cover data for the geographic area,
wherein the one or more trained models are also applied to the building data and the terrain data to select the data acquisition modality from the multiple data acquisition modalities for each of the geographic sub-areas.

8. The non-transitory computer-readable medium of claim 1, the method further comprising receiving historical wildfire data for the geographic area, the historical wildfire data including portions of the geographic area affected by historical wildfire, wherein the one or more trained models are also applied to the historical wildfire data to select the data acquisition modality from the multiple data acquisition modalities for each of the geographic sub-areas.

9. The non-transitory computer-readable medium of claim 1, the method further comprising receiving historical outage data for the electrical assets, the historical outage data including the electrical assets affected by historical outages, wherein the one or more trained models are also applied to the historical outage data to select the data acquisition modality from the multiple data acquisition modalities for each of the geographic sub-areas.

10. The non-transitory computer-readable medium of claim 1, the method further comprising receiving weather data for the geographic area, the weather data including one or more of historical weather data for the geographic area or forecasted weather data for the geographic area, wherein the one or more trained models are also applied to the weather data to select the data acquisition modality from the multiple data acquisition modalities for each of the geographic sub-areas.

11. The non-transitory computer-readable medium of claim 1, the method further comprising receiving vegetation management data for the electrical assets, the vegetation management data including historical vegetation management activities proximate to the electrical assets, wherein the one or more trained models are also applied to the vegetation management data to select the data acquisition modality from the multiple data acquisition modalities for each of the geographic sub-areas.

12. A method comprising:
receiving asset data for infrastructure assets located in a geographic area;
receiving first satellite images of the geographic area, the first satellite images having a first resolution;
receiving requirements data, the requirements data including one or more requirements relating to the infrastructure assets or the geographic area;
dividing at least a portion of the geographic area into geographic sub-areas;
applying one or more trained models to the first satellite images and the requirements data to select a data acquisition modality from multiple data acquisition modalities for each of the geographic sub-areas, the multiple data acquisition modalities including:
one or more satellites configured to capture satellite data, the satellite data including second satellite images, at least some of the second satellite images having a second resolution different from the first resolution,
one or more aerial modalities configured to capture aerial data from the air, the aerial data including one or more of images, LiDAR data, hyperspectral data, infrared data, ultraviolet data, or other sensor data, and
one or more surface modalities configured to capture surface data from the surface, the surface data including one or more of images, LiDAR data, hyperspectral data, infrared data, ultraviolet data, or other sensor data;
generating, for a particular geographic sub-area, a request to receive data of the data acquisition modality selected for the particular geographic sub-area;
receiving data captured by the data acquisition modality;
generating or updating, based on the data captured by the data acquisition modality, one or more analytic outputs for the particular geographic sub-area or particular electrical assets located in the particular geographic sub-area; and
providing the one or more analytic outputs for the particular geographic sub-area or the particular electrical assets located in the particular geographic sub-area.

13. The method of claim 12, further comprising wherein the one or more trained models are also applied to the first satellite images and the requirements data to determine a frequency or timing of capture of the data acquisition modality.

14. The method of claim 12 wherein the one or more analytic outputs are one or more second analytic outputs, and further comprising generating, based on the first satellite images, one or more first analytic outputs, wherein generating or updating the one or more analytic outputs for the particular geographic sub-area or the particular electrical assets located in the particular geographic sub-area includes updating, further based on the one or more second analytic outputs, the one or more first analytic outputs.

15. The method of claim 12 wherein the one or more requirements include a wildfire risk assessment for the geographic area, and the one or more analytic outputs include the wildfire risk assessment for the particular geographic sub-area.

16. The method of claim 12 wherein the one or more requirements include a hazard tree assessment for the geographic area, and the one or more analytic outputs include the hazard tree assessment for the particular geographic sub-area.

17. The method of claim 12, further comprising:
receiving building data for the geographic area, the building data including one or more locations of one or more buildings in the geographic area; and
receiving terrain data for the geographic area, the terrain data including land use and land cover data for the geographic area,
wherein the one or more trained models are also applied to the building data and the terrain data to select the data acquisition modality from the multiple data acquisition modalities for each of the geographic sub-areas.

18. The method of claim 12, the method further comprising receiving historical wildfire data for the geographic area, the historical wildfire data including portions of the geographic area affected by historical wildfire, wherein the one or more trained models are also applied to the historical wildfire data to select the data acquisition modality from the multiple data acquisition modalities for each of the geographic sub-areas.

19. The method of claim 12, the method further comprising receiving historical outage data for the infrastructure assets, the historical outage data including the infrastructure assets affected by historical outages, wherein the one or more trained models are also applied to the historical outage data to select the data acquisition modality from the multiple data acquisition modalities for each of the geographic sub-areas.

20. The method of claim 12, the method further comprising receiving weather data for the geographic area, the weather data including one or more of historical weather data for the geographic area or forecasted weather data for the geographic area, wherein the one or more trained models are also applied to the weather data to select the data acquisition modality from the multiple data acquisition modalities for each of the geographic sub-areas.

21. The method of claim 12, the method further comprising receiving vegetation management data for the infrastructure assets, the vegetation management data including historical vegetation management activities proximate to the infrastructure assets, wherein the one or more trained models are also applied to the vegetation management data to select the data acquisition modality from the multiple data acquisition modalities for each of the geographic sub-areas.

22. A system comprising at least one processor and at least one memory including executable instructions that when executed by the at least one processor cause the system to:
receive asset data for infrastructure assets located in a geographic area;
receive first satellite images of the geographic area, the first satellite images having a first resolution;
receive requirements data, the requirements data including one or more requirements relating to the infrastructure assets or the geographic area;
divide at least a portion of the geographic area into geographic sub-areas;
apply one or more trained models to the first satellite images and the requirements data to select a data acquisition modality from multiple data acquisition modalities for each of the geographic sub-areas, the multiple data acquisition modalities including:
one or more satellites configured to capture satellite data, the satellite data including second satellite images, at least some of the second satellite images having a second resolution different from the first resolution,
one or more aerial modalities configured to capture aerial data from the air, the aerial data including one or more of images, LiDAR data, hyperspectral data, infrared data, ultraviolet data, or other sensor data, and
one or more surface modalities configured to capture surface data from the surface, the surface data including one or more of images, LiDAR data, hyperspectral data, infrared data, ultraviolet data, or other sensor data;
generate, for a particular geographic sub-area, a request to receive data of the data acquisition modality selected for the particular geographic sub-area;
receive data captured by the data acquisition modality;
generate or update, based on the data captured by the data acquisition modality, one or more analytic outputs for the particular geographic sub-area or particular electrical assets located in the particular geographic sub-area; and
provide the one or more analytic outputs for the particular geographic sub-area or the particular electrical assets located in the particular geographic sub-area.
